(19) United States
(12) Patent Application Publication
(10) Pub. No.: US 2018/0149197 A1
(43) Pub. Date: May 31, 2018

(54) THRUST BEARING FOR HYDRAULIC CONTINUOUSLY VARIABLE TRANSMISSION

(71) Applicant: NTN CORPORATION, Osaka (JP)

(72) Inventor: Hiroki TANIMURA, Mie (JP)

(21) Appl. No.: 15/575,517

(22) PCT Filed: Apr. 26, 2016
(86) PCT No.: PCT/JP2016/063012

§ 371 Date: Nov. 20, 2017

(30) Foreign Application Priority Data
May 22, 2015 (JP) 2015-104401

(51) Int. Cl. F16C 33/44; F16C 19/10

(52) U.S. Cl. CPC F16C 33/44; F16C 2326/01; F16C 19/10

(57) ABSTRACT

A thrust bearing for a hydro-static transmission according to the present invention is incorporated in a hydro-static transmission and includes: an inner ring which makes contact with pistons of piston chambers of a variable capacity pump; an outer ring fixed to a swash plate; a plurality of balls held between the inner ring and the outer ring via a retainer, where the retainer is made of a synthetic resin provided by polyamide 66, and contains glass fiver at a rate not greater than 10 mass percent. With this arrangement, the present invention prevents breakage of the retainer caused by delayed or speeded balls resulting from an imbalanced load when the pump swash plate varies its slant angle, thereby provides a long-life thrust bearing for a hydro-static transmission.

### TECHNICAL FIELD

The present invention relates to thrust bearings for use in hydro-static transmissions.

### BACKGROUND ART

Hydro-static transmissions are utilized in agricultural equipment such as lawn mowers (see Patent Literature 1 for example). In such hydro-static transmissions, thrust bearings are utilized at places for receiving piston pressure at a time when rotational force of the shaft is converted to hydraulic pressure or when hydraulic pressure is converted to rotational force of the shaft.

For these thrust bearings which are incorporated in hydro-static transmissions and used under high load conditions, various proposals have been made for improved shape of their track rings and retainers.

Patent Literature 2 proposes such a thrust bearing: In an attempt to prevent breakage of the retainer, the retainer is made of a glass-fiber reinforced synthetic resin, and a specific amount of a pocket gap is provided to absorb impact onto the retainer caused by delayed or speeded travel of the balls.

### CITATION LIST

### Patent Literature

Patent Literature 1: JP-A-2003-194183

Patent Literature 2: JP-A-2013-64495

### SUMMARY OF INVENTION

### Technical Problem

Normally, thrust bearings are used to bear axial load from one direction. Thrust bearings used in hydro-static transmissions work under varying load conditions with a varying slant angle of a pump swash plate, and therefore, can be broken under an imbalanced load. In particular, the imbalanced load can delay or speed the balls, leading to breakage of the retainer.

It is an object of the present invention to solve the above-described problem, reduce load on the retainer, and provide a thrust bearing for hydro-static transmission which has a longer life.

### Solution to Problem

In order to achieve the above-described object, the present invention provides a thrust bearing which is incorporated in a hydro-static transmission and includes: an inner ring which makes contact with pistons of piston chambers of a variable capacity pump or of a variable capacity motor; an outer ring fixed to the swash plate; a plurality of rolling elements held between the inner ring and the outer ring via a retainer. The retainer is made of a synthetic resin provided by polyamide 66, and the polyamide 66 of the retainer contains glass fiver at a rate not greater than 10 mass percent.

Also, preferably, the retainer has each of its pockets provided by a combination of a cylindrical hole and a spherical surface, with a pocket gap being 2 through 4 percent of a diameter (D) of the rolling element.

### Advantageous Effects of Invention

As mentioned above, in the present invention, a material for the retainer is provided by polyamide 66 containing glass fiber at a rate not greater than 10 percent, whereby the retainer has increased elasticity and is capable of reducing a load born by pockets when the rolling elements are delayed or speeded.

### BRIEF DESCRIPTION OF DRAWINGS

FIG. 1 is a sectional view which shows an example of hydro-static transmission.

FIG. 2 is a sectional view which shows an example of thrust bearing.

FIG. 3 is a sectional view which shows an example of retainer.

### DESCRIPTION OF EMBODIMENTS

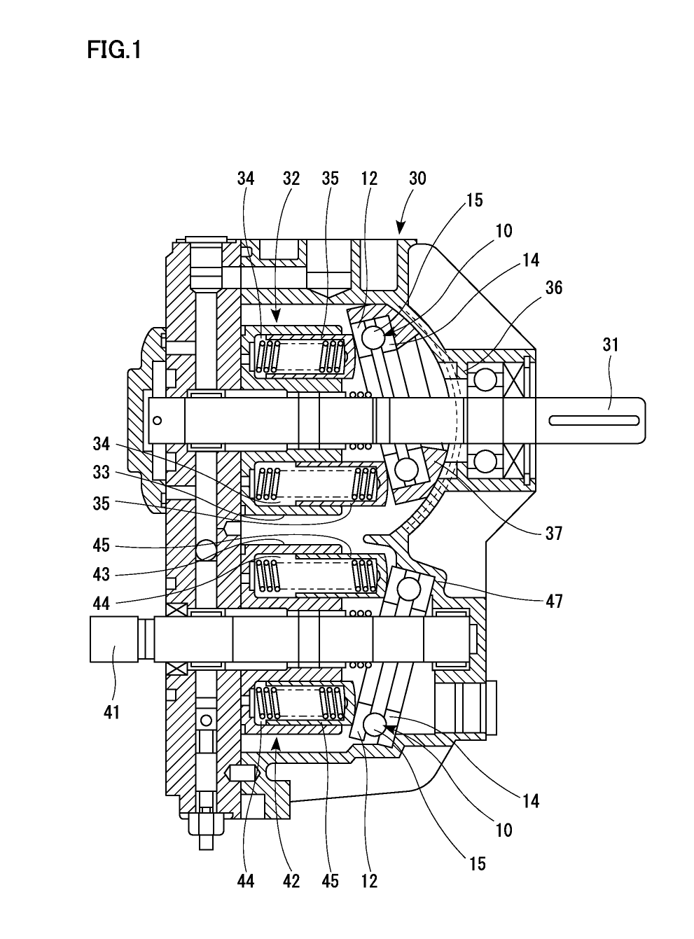

Hereinafter, embodiments of the present invention will be described based on the attached drawings. FIG. 1 is a sectional view which shows an example of hydro-static transmission mechanism.

As shown in FIG. 1, a hydro-static transmission 30 includes a variable capacity pump 32 which converts rotational driving force transmitted from an unillustrated engine to an input shaft 31 into hydraulic pressure, and a variable capacity motor 42 which converts the hydraulic pressure back into rotational driving force and transmits the rotational driving force to an output shaft 40. By changing a swash plate angle in the variable capacity pump 32, rotational driving force transmitted to the input shaft 31 is changed in a stepless fashion over a range from forward travel to rearward travel before it is outputted from the output shaft 41, or to stop the output.

The variable capacity pump 32 includes: a cylinder block 33 which rotates integrally with the input shaft 31; nose pistons 35 which are disposed at a plurality of locations in a circumferential direction of the cylinder block 33 and make reciprocal movement within their respective piston chambers 34; and a swash plate 37 which pivots along a guide surface of a guide block 36. In the variable capacity pump 32, the nose pistons 35 reciprocate within a variable stroke length as the swash plate 37 pivots, thereby varying the amount of oil outputted from the piston chambers 34. A thrust bearing 10 is disposed at a place where the swash plate 37 makes contact with the tips of nose pistons 35. The thrust bearing 10 rotates together with the swash plate 37.

The variable capacity motor 42 includes: a cylinder block 43 which rotates integrally with the output shaft 41; nose pistons 45 which are disposed at a plurality of locations in a circumferential direction of the cylinder block 43 and make reciprocal movement within their respective piston chambers 44; and a swash plate 47. A thrust bearing 10 is disposed at a place where the swash plate 47 makes contact with tips of the nose pistons 45.

As the variable capacity pump 32 outputs oil from each of its piston chambers 34, the oil is supplied to the piston chambers 44 in the cylinder block 43. Each nose piston 45 is moved to reciprocate within their piston chamber 44, whereby the output shaft 41 is rotated in a forward driving or rearward driving direction at a speed determined by the amount of oil outputted from the variable capacity pump 32.

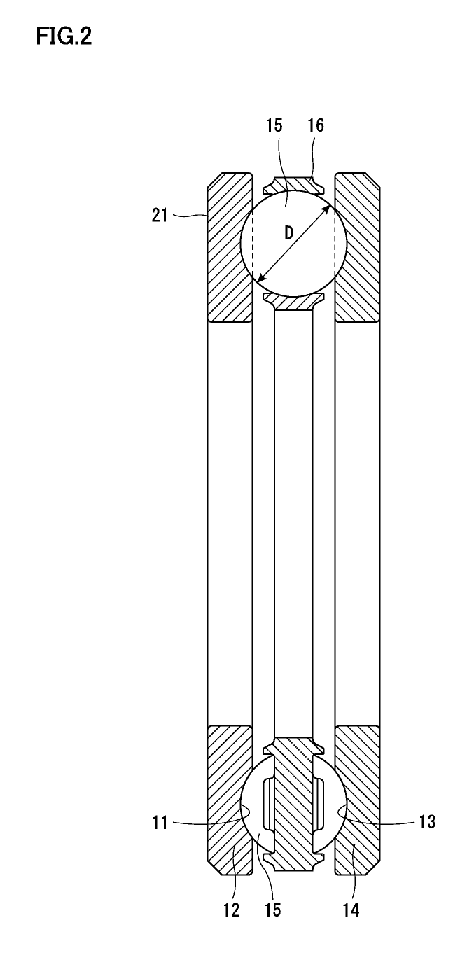

As shown in FIG. 2, in the thrust bearing 10, an inner ring 12 which has an inner ring track surface 11 and an outer ring 14 which has an outer ring track surface 13 are opposed to each other, and a plurality of balls 15 serving as rolling elements are rollably disposed between the inner ring track surface 11 and the outer ring track surface 13. Further, the thrust bearing 10 has a retainer 16 which holds the plurality of balls 15 equidistantly in the circumferential direction.

The inner ring 12 is rotatable, and is contacted by the tips of nose pistons 35 (45) on its end face 21 on the side away from the side formed with the inner ring track surface 11. On the other hand, the outer ring 14 is fixed to the swash plate 37. For this reason, the thrust bearing 10 receives a heavy load from the nose pistons 35 (45) with the inner ring 12, and releases the load via the balls 15, to the outer ring 14 which is fixed to the swash plate 37 (47).

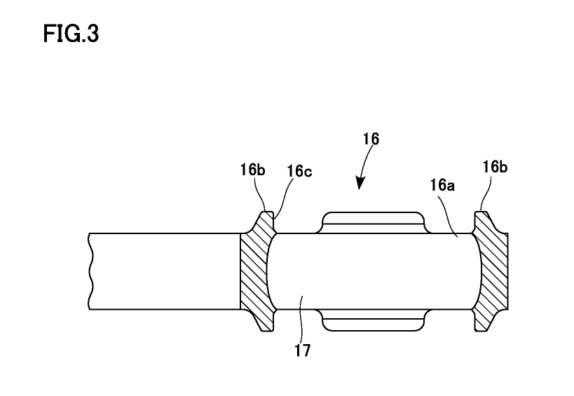

While there is no limitation to the shape of the retainer 16 in the present invention, the shape thereof may be as shown in FIG. 2 and FIG. 3 for example. FIG. 3 is a sectional view which shows a state shown in FIG. 2, with the ball 15 removed.

As shown in FIG. 2 and FIG. 3 for example, the retainer 16 in the present embodiment has an annular base 16a formed with a plurality of pockets 17. Each pocket 17 is provided by a combination of a cylindrical hole and a spherical surface. With this arrangement, the pocket 17 has pawl portions 16b protruding more outward than the base 16a, at a plurality of its circumferential locations, i.e., equidistantly at four locations in this particular embodiment. Also, each pawl portion 16b has an elastically deformable, generally vertical pocket-side surface 16c for easy placement of the balls 15 at the time of assembling.

In the embodiment of the present invention, the retainer 16 is made of a synthetic resin out of a concern that delayed or speeded travel of the balls 15 serving as the rolling elements can make impact on pocket surfaces and lead to breakage of the retainer 16. Among many synthetic resins, polyamide 66 is utilized for its durability, elasticity, and so on. Also, polyamide 66 is inexpensive as a raw material. It should be noted that the retainer 16 made of the synthetic resin contains glass fiber for reinforcement.

In a hydro-static transmission where imbalanced load is applied to the thrust bearing 10, the retainer 16 is faced with another problem that as the balls 15 are delayed or speeded, the distance between one ball 15 and another ball 15 becomes longer. Therefore, it is most important to decrease a load born by the pockets 17. Although one effective solution can be to increase a gap in the pockets 17, this decreases strength of the pockets 17, i.e., this is not a preferred option. With this in mind, in the present embodiment, the pocket gap is made to be 2 through 4 percent of a diameter (D) of the balls 15. In other words, manipulating only on the gap in the pockets 17 is not enough to decrease the load from the balls.

As has been mentioned earlier, the retainer 16 made of synthetic resin contains glass fiber for reinforcement. Increasing the glass fiber contents gives the retainer 16 greater tensile strength and rigidity, lowers the ability to reduce impact on the pockets 17 as the balls 15 are delayed or speeded, and leads breakage. As a solution, in the present embodiment, the amount of glass fiber to be mixed with polyamide 66 is decreased to reduce breakage risk of the retainer 16. In order to identify a suitable amount of the glass fiber content, a number of samples of polyamide 66 each containing a different amount of glass fiber were prepared to conduct a durability test.

### Embodiment

### (Test 1)

Polyamide 66 materials which contained glass fiber by the amount of 0, 10 mass percent, 25 mass percent, and 40 mass percent were used to make retainers, and each synthetic-resin retainer was subjected to moment-load conditions which simulated delayed and speeded movement of the balls, to see durability. The test was performed by using thrust ball bearings having an inner diameter of 30 mm, an outer diameter of 52.5 mm, and a height of 12 mm, and turbine oil as a lubricant. Also, the synthetic-resin retainers were made to have a pocket gap of 3 percent. Test conditions include: 4900N axial load, 980N radial load, 3000 min⁻¹ number of rotations, and 20 degrees Celsius ambient temperature.

Table 1 shows results of Test 1.

TABLE 1

| Glass Fiber Amount (%) | Passed or Failed |
|---|---|
| 0 | Passed |
| 10 | Passed |
| 25 | Failed |
| 40 | Failed |

The test revealed that the retainers containing glass fiber by the amount of 0 and 10 mass percent were not destroyed. On the contrary, the retainers containing glass fiber by the amount of 25 mass percent and 40 mass percent were elongated as the balls were delayed or speeded, which developed cracks, and finally the retainers were broken at the elongated points. From the above, it is best to use a polyamide 66 material containing glass fiber by the mass percentage of not greater than 10 percent. Also, it is noted that the thrust bearing 10 is not suitable for high-speed rotation, and that it is possible to provide sufficient strength if the glass fiber content is not more than 10 mass percent.

All of the embodiments disclosed herein are to show examples, and should not be considered as of a limiting nature in any way. The scope of the present invention is identified by the claims and is not by the descriptions of the Embodiment Examples given hereabove, and it is intended that the scope includes all changes falling within equivalents in the meaning and extent of the Claims.

### REFERENCE SIGNS LIST

10: Thrust Bearing
11: Track Surface
12: Inner Ring
13: Track Surface
14: Outer Ring
15: Ball
16: Retainer
17: Pocket
21: End Face
30: Hydro-Static Transmission
31: Input Shaft
32: Variable Capacity Pump
33: Cylinder Block
34: Piston Chamber
35: Nose Piston
36: Guide Block
37: Swash Plate
40: Output Shaft
41: Output Shaft
42: Variable Capacity Motor
43: Cylinder Block
44: Piston Chamber
45: Nose Piston
47: Swash Plate

1. A thrust bearing for incorporation in a hydro-static transmission, comprising: an inner ring which makes contact with pistons in piston chambers of a variable capacity pump or a variable capacity motor; an outer ring fixed to a swash plate; and a plurality of rolling elements between the inner ring and the outer ring via a retainer;
wherein the retainer is made of a synthetic resin provided by polyamide 66, and the polyamide 66 contains glass fiber at a rate not greater than 10 mass percent.

2. The thrust bearing for hydro-static transmission according to claim 1, wherein the retainer has each of its pockets provided by a combination of a cylindrical hole and a spherical surface, with a pocket gap being 2 through 4 percent of a diameter (D) of the rolling element.
